(19) United States
(12) Patent Application Publication
(10) Pub. No.: US 2009/0086697 A1
(43) Pub. Date: Apr. 2, 2009

(54) Information Communication Terminal Having Wireless Communication Function

(75) Inventor: Koki Okada, Kyoto-shi (JP)

Correspondence Address: FISH & RICHARDSON P.C;Citigroup Center, 52nd floor, 153 East 53rd Street, New York, NY, 10022-4611, US

(73) Assignee: Rohm Co., Ltd., Kyoto (JP)

(21) Appl. No.: 12/237,561

(22) Filed: Sep. 25, 2008

(30) Foreign Application Priority Data
Sep. 28, 2007 (JP) 2007-253931

(51) Int. Cl. H04W 4/00

(52) U.S. Cl. 370/338

(57) ABSTRACT

A terminal includes a communication unit. The communication unit determines which one of an AP mode and an ST mode is set as an operating mode of the terminal. In the ST mode, the communication unit accepts a received frame, and then outputs the accepted frame to a host system. In the AP mode, the communication unit transmits the received frame as it is to a wireless network, that is, relays the frame.

### BACKGROUND OF THE INVENTION

1. Field of the Invention

The present invention relates to information communication terminals, in particular, an information communication terminal to be applied for wireless communications.

2. Description of the Background Art

Recently, wireless communications carried out by a plurality of information communication terminals without using a base station (an access point) tend to become widespread. Herein, a network configured with only terminals capable of carrying out such wireless communications is called an ad hoc network. On the other hand, a network on which wireless communications are carried out through a base station is called an infrastructure mode network.

There have been disclosed various techniques concerning a terminal capable of carrying out communications on an infrastructure mode network. For example, Japanese Patent Laying-Open No. 2005-098560 discloses a configuration that an access point is provided for carrying out communications through use of home terminals and a wireless LAN (Local Area Network). Herein, the access point operates to relay communications between these terminals and a server on an external internet network.

On a wireless LAN, each terminal can carry out communications with only a terminal that exists in a range capable of receiving a radio wave transmitted therefrom. For this reason, there has been demanded extension of such a communication range. However, in a case where a dedicated access point for special use is provided as disclosed in Japanese Patent Laying-Open No. 2005-098560, there arises a problem of increase in cost.

### SUMMARY OF THE INVENTION

An object of the present invention is to provide an information communication terminal capable of extending a communication range without providing a dedicated access point on a wireless network.

In order to achieve the object described above, according to one aspect of the present invention, an information communication terminal for carrying out communications on a wireless network includes a communication unit carrying out communications with an external apparatus using a frame on the wireless network, and an information processing unit performing information processing using the frame received by the communication unit.

The communication unit includes a mode determination portion determining which one of a first mode and a second mode is set as an operating mode of the information communication terminal. When the mode determination portion determines that the operating mode is set at the first mode, the communication unit outputs the received frame to the information processing unit. When the mode determination portion determines that the operating mode is set at the second mode, the communication unit transmits the received frame to the wireless network.

Preferably, the information communication terminal further includes a power supply unit supplying electric power to each circuit of the information communication terminal, and a charge state determination unit determining whether the power supply unit is in a charge state. The operating mode is set at one of the first mode and the second mode in accordance with a result of the determination by the charge state determination unit.

Preferably, when the charge state determination unit determines that the power supply unit is in the charge state, the operating mode is set at the second mode.

Preferably, the power supply unit becomes charged with electric power supplied from a power feed line connected to the information communication terminal. The information processing unit includes an external communication portion transmitting the received frame to the external through the power feed line. When the charge state determination unit determines that the power supply unit is in the charge state and the information communication terminal is instructed to carry out communications with the external, the operating mode is set at the first mode.

Preferably, when the charge state determination unit determines that the power supply unit is in the charge state and the information communication terminal is instructed to allow the information processing unit to execute a predetermined application, the operating mode is set at the first mode.

Preferably, the communication unit includes a program storage portion having a predetermined storage area in which a program inputted from the information processing unit is stored in an overwriting manner, and operates in accordance with the program stored in the predetermined storage area. When the operating mode is set at the first mode, the information processing unit outputs to the communication unit a first program for allowing the communication unit to serve as the first mode. When the operating mode is set at the second mode, the information processing unit outputs to the communication unit a second program for allowing the communication unit to serve as the second mode.

Preferably, the external apparatus is another information communication terminal which is equal in configuration to the information communication terminal described above.

In order to achieve the object described above, according to another aspect of the present invention, a wireless communication device is installed in an information communication terminal for carrying out communications on a wireless network. The wireless communication device includes a communication unit carrying out communications with an external apparatus using a frame on the wireless network, and an information processing unit performing information processing using the frame received by the communication unit.

The communication unit includes a mode determination portion determining which one of a first mode and a second mode is set as an operating mode of the information communication terminal. When the mode determination portion determines that the operating mode is set at the first mode, in the wireless communication device, the communication unit accepts the received frame and outputs the frame to the information processing unit. Moreover, when the mode determination portion determines that the operating mode is set at the second mode, the communication unit transmits the received frame through the wireless network.

In order to achieve the object described above, according to still another aspect of the present invention, a wireless communication network includes a plurality of information communication terminals. The plurality of information communication terminals carry out mutual wireless communications with one another.

A first information communication terminal among the plurality of information communication terminals includes a communication unit carrying out wireless communications with a second information communication terminal among the plurality of information communication terminals using a frame, and an information processing unit performing information processing using the frame received by the communication unit.

The communication unit includes a mode determination portion determining which one of a first mode and a second mode is set as an operating mode of the first information communication terminal. When the mode determination portion determines that the operating mode is set at the first mode, in the first information communication terminal, the communication unit accepts the received frame and outputs the frame to the information processing unit. Moreover, when the mode determination portion determines that the operating mode is set at the second mode, the communication unit transmits the received frame by the wireless communication.

According to the present invention, when the first mode is set as the operating mode, the frame received by the communication unit on the wireless network is outputted to the information processing unit. On the other hand, when the second mode is set as the operating mode, the frame received by the communication unit on the wireless network is transmitted as it is to the wireless network through the communication unit without being outputted to the information processing unit. Thus, a frame relaying operation is performed in the second mode.

Accordingly, in an ad hoc network for wireless communications (a network configured with only station terminals), a station terminal is allowed to have a frame relaying function which is similar to that of an access point. Thus, indirect communications (frame relaying operations) are carried out between station terminals, leading to extension of a communication range.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows one example of a configuration of a wireless communication network according to one embodiment of the present invention.

FIG. 2 schematically shows a hardware configuration of a terminal according to the embodiment of the present invention.

FIG. 3 shows a configuration of a program memory of the terminal according to the embodiment of the present invention.

FIG. 4 schematically shows a configuration of a frame (a beacon frame) to be transmitted/received on the network according to the embodiment of the present invention.

FIG. 5 shows a process flowchart of operations of a host system according to the embodiment of the present invention.

FIG. 6 shows a flowchart of operations of a communication circuit in an AP mode according to the embodiment of the present invention.

FIG. 7 shows a flowchart of operations of the terminal in an ST mode according to the embodiment of the present invention.

### DESCRIPTION OF THE PREFERRED EMBODIMENTS

With reference to the drawings, hereinafter, description will be given of a wireless communication network according to one embodiment of the present invention.

It is assumed in this embodiment that communications are carried out in accordance with the IEEE (Institute of Electrical and Electronics Engineers, Inc.) 802.11 standard which is one of standards for a wireless LAN (Local Area Network).

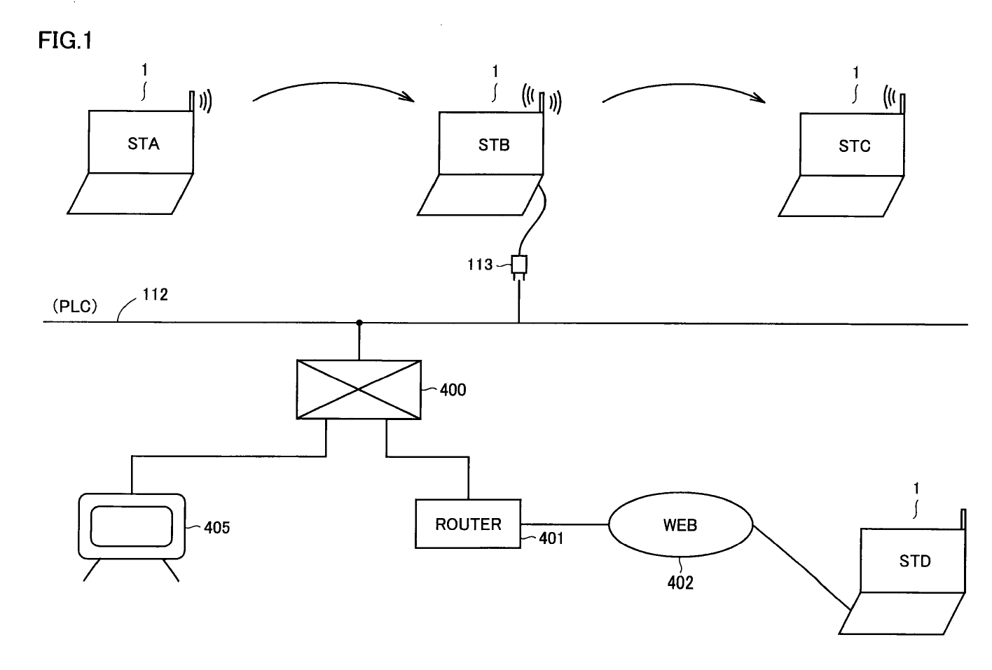

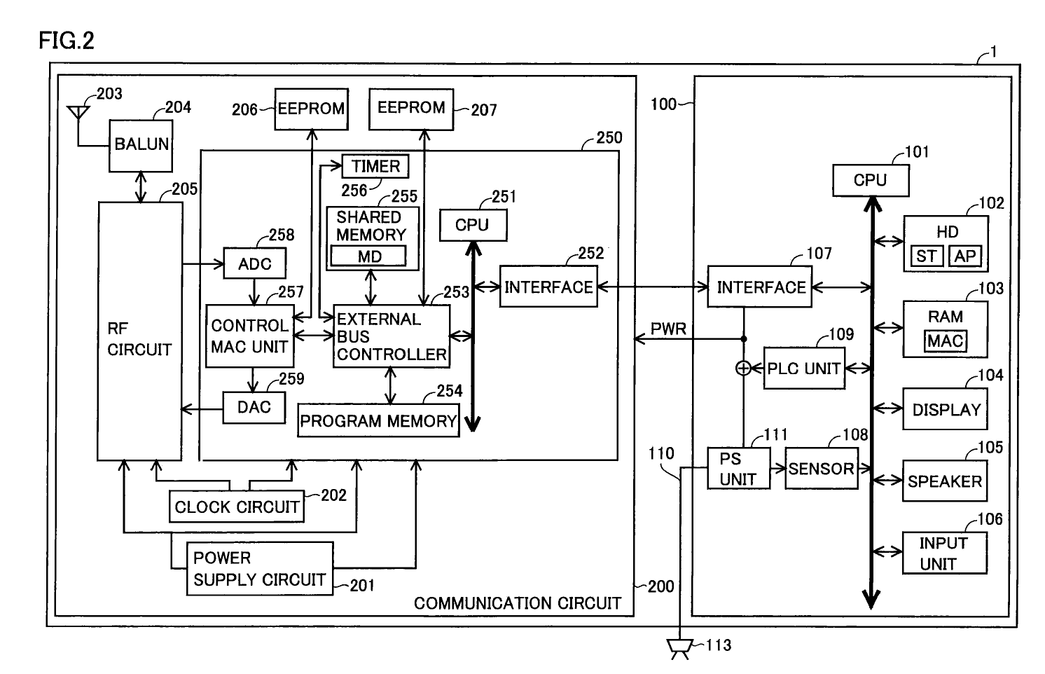

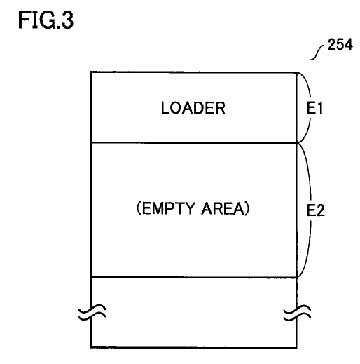

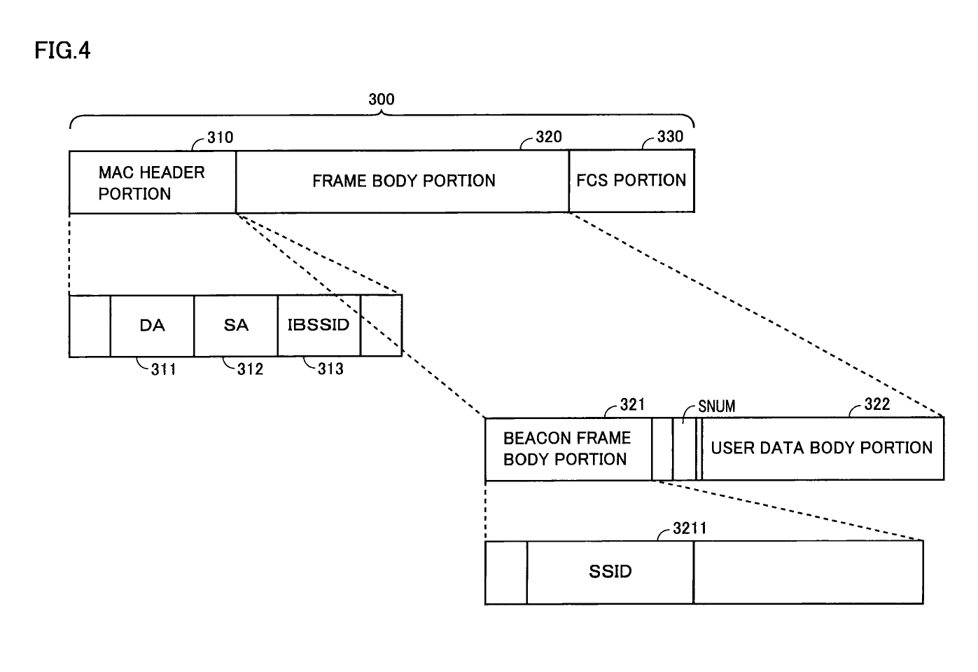

FIG. 1 schematically shows one example of a configuration of an ad hoc network which is the wireless communication network according to this embodiment. FIGS. 2 and 3 show a hardware configuration of a terminal 1 according to this embodiment. FIG. 4 shows a configuration of a frame which is in conformity with the IEEE 802.11 standard.

With reference to FIG. 1, the wireless communication network includes terminals STA, STB and STC. The wireless communication network also includes a PLC (Power Line Communication) network connected thereto through a power feed line 112 for PLC which is connected to terminal STB through a plug 113. The PLC network includes a bridge device 400 connected to power feed line 112, a television set 405 and a router 401 each connected to bridge device 400, a WEB (World Wide Web) 402 connected to router 401, and a plurality of terminals 1 (to be described later) such as a terminal STD connected to WEB 402. In FIG. 1, terminals STA, STB and STC as well as terminal STD are similar in function and configuration to terminal 1 to be described later.

With reference to FIG. 2, terminal 1 is mainly configured with a host system 100 and a communication circuit 200. Host system 100 includes a CPU (Central Processing Unit) 101 for collectively controlling operations of host system 100. In host system 100, moreover, various application programs are executed. In this specification, the application program is simply referred to as “application” in some instances. The application program to be executed is stored in an HD (Hard Disk) 102. Host system 100 also includes a RAM (Random Access Memory) 103 for storing a working area of CPU 101, a MAC (Media Access Control) address of terminal 1, and the like, a display 104 for displaying information, a speaker 105 for outputting voice, an input unit 106, such as a key or a button, for accepting an external information input, a PS (Power Supply) unit 111 having a function of supplying electric power to each part of terminal 1 and a function of becoming charged, a sensor 108 for detecting and outputting a remaining voltage level of PS unit 111, and a PLC unit 109 for controlling communications based on PLC.

PS unit 111 becomes charged while being supplied with electric power from a commercial power supply (not shown) through a line 110. In the charge state, line 110 is connected to power feed line 112 in a home through plug 113. Therefore, host system 100 can carry out communications with each terminal 1 (such as terminal STD shown in FIG. 1) on the external PLC network through PS unit 109, PS unit 111, line 110 and power feed line 112.

Host system 100 also includes an interface 107 for exchanging information (signals or data) with communication circuit 200. PS unit 111 supplies electric power to communication circuit 200.

In this embodiment, terminal 1 operates in accordance with one of an infrastructure mode for carrying out communications with another terminal 1 through an access point and an ad hoc mode for carrying out communications with another terminal 1 through no access point, as a communication function of the wireless LAN. In this embodiment, terminal 1 is used as an access point. Accordingly, terminal 1 is switched so as to serve as an access point or to serve as a station. Terminal 1 serves as an access point or a station in accordance with a program to be loaded into (stored in) a memory of communication circuit 200 in terminal 1. A program AP for allowing terminal 1 to serve as an access point and a program ST for allowing terminal 1 to serve as a station are stored in HD 102 in advance.

Communication circuit 200 includes a base band/MAC circuit 250, an RF (Radio Frequency) circuit 205, a balun 204, an antenna 203, EEPROMs (Electronically Erasable and Programmable Read Only Memories) 206 and 207, a power supply circuit 201, and a clock circuit 202.

Clock circuit 202 generates a clock signal, and then supplies the generated clock signal to each of base band/MAC circuit 250 and RF circuit 205. Power supply circuit 201 controls supply of electric power PWR from PS unit 110 to each of base band/MAC circuit 250 and RF circuit 205.

RF circuit 205 performs data transmission/reception through antenna 203. Balun 204 is provided between antenna 203 and RF circuit 205.

Base band/MAC circuit 250 includes a CPU 251, an interface 252, an external bus controller 253, a program memory 254, a shared memory 255, a timer 256, a control MAC unit 257, an ADC (Analog-to-Digital Converter) 258 and a DAC (Digital-to-Analog Converter) 259. Herein, CPU 251 controls the respective portions of base band/MAC circuit 250 and exchanges signals and data with the respective portions of base band/MAC circuit 250. Interface 252 is an interface to host system 100.

Shared memory 255 stores mode data ‘MD’ indicating a current operating mode of terminal 1. Mode data ‘MD’ indicates one of an AP mode in which terminal 1 is operable as an access point, an ST mode in which terminal 1 is operable as a station and a PLC mode in which host system 100 is operable for PLC.

With reference to FIG. 3, program memory 254 includes regions E1 and E2. Region E2 can store a program. However, when no electric power is supplied to terminal 1, data stored in region E2 is erased, so that region E2 becomes empty of data. On the other hand, region E1 stores a loader which is a dedicated program for loading a program into region E2. Therefore, even when no electric power is supplied to terminal 1, data stored in region E1 is held (is not erased). In program memory 254, the loader in region E1 is a resident program. On the other hand, a program to be stored in region E2 corresponds to program AP or program ST stored in HD 102. Each of program AT and program ST is a non-resident program in region E2, and is loaded into (stored in) region E2 from HD 102 if necessary.

In operations, CPU 251 receives from host system 100 a command to transmit data to the network, and then allows interface 252 to retrieve the relevant data stored in the memory (e.g., RAM 103) of host system 100. Herein, host system 100 generates data indicating the transmission, allows the memory to store the generated data, and transmits to communication circuit 200 a command to transmit the data. Moreover, the data retrieved by interface 252 is temporarily stored in program memory 254, as data forming “a user data body portion” of a frame to be transmitted to the network.

Then, CPU 251 adds various kinds of data such as a MAC header and a FCS (Frame Check Sequence) to the data stored in program memory 254 to generate a frame to be transmitted to the network. CPU 251 allows program memory 254 to store the frame generated as described above, and sets a flag indicating the generation of the frame in shared memory 255. With reference to FIG. 4, herein, description will be given of a configuration of a beacon frame which is one example of the frame to be transmitted to the network.

FIG. 4 shows a configuration of a frame which is conformity with the IEEE 802.11 standard.

With reference to FIG. 4, frame 300 contains a MAC header portion 310, a frame body portion 320 and a FCS portion 330.

MAC header portion 310 contains a DA (Destination Address) 311, an SA (Source Address) 312 and an IBSSID (Independent Basic Service Set Identifier) 313. DA 311 indicates a destination address of frame 300. SA 312 indicates a source address of frame 300. Each of DA 311 and SA 312 is a MAC address of 6 bytes. These addresses are stored in EEPROM 207. Moreover, IBSSID 313 is network identification information for identifying the ad hoc network. In this embodiment, terminal 1 can utilize different IBSSIDs upon transmission of data in accordance with an attribute of the data to be transmitted (i.e., data of which the transmission is requested through an application executed in host system 100). Specifically, a value of IBSSID 313 forming MAC header portion 310 is changed in accordance with the attribute of the data to be transmitted.

Frame body portion 320 contains a beacon frame body portion 321, a user data body portion 322 and data ‘SNUM’. Beacon frame body portion 321 contains an SSID (Service Set Identifier) 3211. SSID 3211 is information for specifying a name of a network, and is set as a character string within 32 bytes, for example. User data body portion 322 contains actual data to be transmitted (i.e., data of which the transmission is requested through an application executed in host system 100). User data body portion 322 contains data of 1500 bytes, for example. Data ‘SNUM’ indicates information (e.g., a serial number) for uniquely identifying the data of user data body portion 322 of frame 300.

It is to be noted that frame 300 shown in FIG. 3 is a beacon frame; therefore, frame body portion 320 contains the data such as the beacon frame body portion. However, in a case where frame 300 is a frame for other purposes, data to be contained in frame body portion 320 is changed appropriately.

FCS portion 330 contains information (an FCS) used for error detection of a frame.

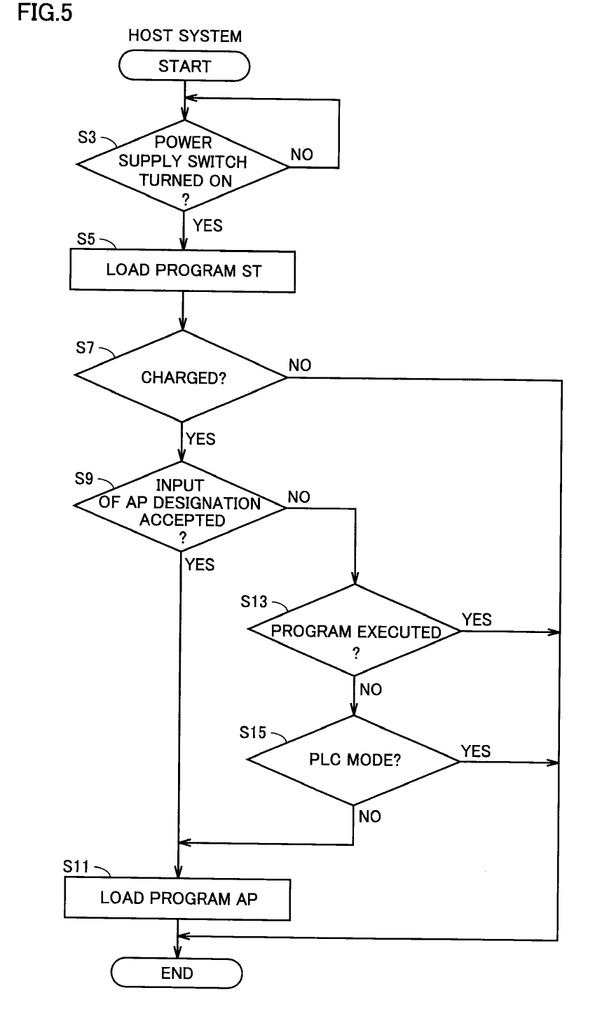

With reference to FIGS. 5 to 7, description will be given of operations for communication performed by terminal 1 in the system shown in FIG. 1. With reference to FIG. 5, first, host system 100 determines whether a power supply switch is turned on through input unit 106 (step S3). When the power supply switch is turned on (YES in step S3), electric power PWR from PS unit 111 is supplied to the respective portions of host system 100, and then is supplied to the respective portions of communication circuit 200 through power supply circuit 201.

Next, CPU 101 reads program ST stored in HD 102 in advance, in accordance with start of supply of the electric power in such a manner that the power supply switch is turned on, and then transmits program ST to communication circuit 200 through interface 107.

In communication circuit 200, interface 252 accepts received program ST, and provides program ST to program memory 254 through external bus controller 253 under control of CPU 251. Program ST provided to program memory 254 is loaded into region E2 by the loader in region E1. Thus, program ST is over written in the empty area of region E2, that is, program ST is stored in the empty area (step S5). Herein, mode data ‘MD’ in shared memory 255 is updated so as to indicate ‘ST mode’.

Next, CPU 101 of host system 100 determines whether PS unit 111 becomes charged (through use of an external commercial power supply), based on a detection output from sensor 108 (step S7). For example, if the detection output from sensor 108 (an output potential from PS unit 111) does not vary or increases, CPU 101 determines that PS unit 111 becomes charged. If not, CPU 101 determines that PS unit 111 does not become charged.

If PS unit 111 does not become charged (NO in step S7), CPU 101 terminates a sequence of processes. If PS unit 111 becomes charged (YES in step S7), CPU 101 determines whether an input of AP designation is accepted (step S9). In other words, CPU 101 determines whether a user inputs AP designation through input unit 106. In a case where the user attempts to use terminal 1 as an access point, then, the user manipulates input unit 106 to input the AP designation.

If CPU 101 determines that the input of the AP designation is accepted, based on a signal from input unit 106 (YES in step S9), then, CPU 101 executes a process of allowing terminal 1 to serve as an access point (step S11). More specifically, CPU 101 reads program AP from HD 102, and transmits program AP to communication circuit 200 through interface 107. In communication circuit 200, interface 252 accepts program AP transferred from host system 100. Herein, program AP is loaded into region E2 of program memory 254 by the loader in region E1 through external bus controller 253. Thus, program AP is overwritten in region E2 of program memory 254, that is, the data in region E2 is updated. Herein, mode data ‘MD’ in shared memory 255 is updated so as to indicate ‘AP mode’.

On the other hand, if CPU 101 determines that no input of the AP designation is accepted through input unit 106 (NO in step S9), then, CPU 101 determines whether to receive a command to execute an application program such as a game which is stored in HD 102, based on a signal from input unit 106 (step S13). If CPU 101 determines that the user inputs a command to execute the application program through input unit 106 (YES in step S13), then, CPU 101 executes the designated application program such as a game. In a case where the designated application program is a game of an interactive type or a match-up type with a user of another terminal 1, there is a possibility that terminal 1 carries out communications with another terminal 1 through use of frame 300 during execution of the application program. Accordingly, when the application program is executed, an operating mode of terminal 1 is set at ‘ST mode’ such that terminal 1 can carry out data communications with another terminal 1. It is to be noted that detailed description of the execution of the application program will not be given here.

On the other hand, if the user inputs no command to execute the application program through input unit 106 (NO in step S13), CPU 101 determines whether the user inputs designation of a PLC mode through input unit 106 (step S15). In a case where the user attempts to use terminal 1 as an access point that relays communications with external terminal 1 (e.g., terminal STD) on the PLC network in accordance with PLC in a state that line 110 is connected to power feed line 112 (a charge state), the user inputs the designation of the PLC mode through input unit 106.

If CPU 101 determines that no designation of the PLC mode is accepted, based on a signal from input unit 106 (YES in step S15), then, CPU 101 executes the process in step S11 as described above. On the other hand, if CPU 101 determines that the designation of the PLC mode is accepted (NO in step S15), then, CPU 101 terminates the sequence of processes. Herein, data of the designated PLC mode is stored in RAM 103 and, also, is provided to communication circuit 200, and data indicating ‘PLC mode’ is stored in shared memory 255.

In accordance with the process procedure shown in FIG. 5, the power supply switch is turned on in host system 100, so that terminal 1 is activated. At this point in time, program ST is loaded into region E2; therefore, terminal 1 can serve as a station terminal. In the charge state (YES in step S7), thereafter, if terminal 1 is designated so as to serve as an access point (AP) that relays communications between terminals 1 (YES in step S9) or if the application program is not executed and the PLC mode is not designated (NO in step S9, NO in step S13 and NO in step S15) in accordance with the command from input unit 106, CPU 101 determines that the user attempts to use terminal 1 as a relay terminal. Then, program AP is loaded into region E2 of program memory 254 such that terminal 1 can serve as an AP terminal.

As described above, host system 100 changes a type of a program to be loaded into region E2, so that terminal 1 can selectively serve as one of an AP terminal having a communication relay function to relay communications and an ST terminal having no communication relay function.

The operation for the communication relay function is performed in the state that terminal 1 becomes charged, leading to elimination of a problem about power consumption.

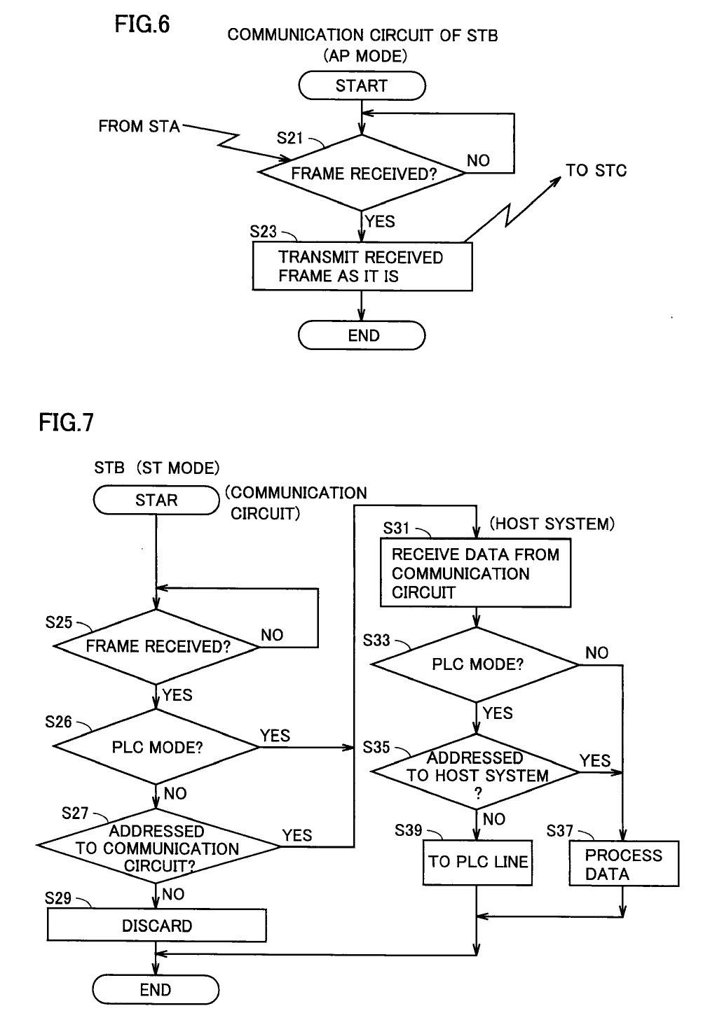

FIG. 6 shows operations of communication circuit 200 of terminal STB shown in FIG. 1 in the AP mode. For example, when communication circuit 200 receives frame 300 for terminal STC from terminal STA (YES in step S21), then, communication circuit 200 executes program AP stored in region E2. In accordance with the execution of program AP, therefore, received frame 300 is inputted to external bus controller 253 via RF circuit 205, ADC 258 and control MAC unit 257. Thereafter, frame 300 inputted as described above is transmitted from antenna 203 to the outside via external bus controller 253, control MAC unit 257, DAC 259 and RF circuit 205 (step S23). Thus, frame 300 is relayed by terminal STB, and then is transferred to each terminal 1 such as terminal STC shown in FIG. 1 which exists near terminal STB.

In the AP mode, as described above, terminal 1 transfers received frame 300 to peripheral terminal 1 immediately without substantially performing no processes on frame 300, that is, performs a relay operation. This configuration allows extension of a wireless communication range (distance) between terminals 1 without delay in communication as much as possible.

With reference to FIG. 7, next, description will be given of operations of terminal STB in the ST mode. For example, when terminal STB receives frame 300 from terminal STA (YES in step S25), received frame 300 is inputted to control MAC unit 257 via RF circuit 205 and ADC 258. Herein, communication circuit 200 executes program ST stored in region E2, so that the following processes are performed in accordance with the execution of program ST.

First, CPU 251 searches shared memory 255 to determine whether data indicating ‘PLC mode’ is stored (step S26). If the data indicating ‘PLC mode’ is stored in shared memory 255 (YES in step S26), the processing procedure proceeds to step S31 to be described later.

On the other hand, if the data indicating ‘PLC mode’ is not stored in shared memory 255 (NO in step S26), external bus controller 253 compares DA 311 of received frame 300 with the MAC address read from EEPROM 207 to determine whether received frame 300 is data addressed to communication circuit 200, based on a result of the comparison (step S27). If the comparison result is good, that is, if received frame 300 is data addressed to communication circuit 200 (YES in step S27), then, frame 300 is given to host system 100 through interface 252 (to step S31). On the other hand, if the comparison result is bad, that is, if received frame 300 is not data addressed to communication circuit 200 (NO in step S27), then, frame 300 is discarded (erased) (step S29).

On the other hand, host system 100 accepts received frame 300 from communication circuit 200 through interface 107 (step S31). Herein, CPU 101 searches RAM 103 to determine whether the data indicating ‘PLC mode’ is stored (step S33). If the data indicating ‘PLC mode’ is stored in RAM 103 (YES in step S33), CPU 101 compares DA 311 of accepted frame 300 with the MAC address read from RAM 103 to determine whether accepted frame 300 is data addressed to host system 100, based on a result of the comparison (step S35). If the comparison result is good, that is, if accepted frame 300 is data addressed to host system 100 (YES in step S35), CPU 101 processes the data in accepted frame 300 in accordance with an application program (step S37).

On the other hand, if the data indicating ‘PLC mode’ is not stored in RAM 103 (NO in step S33), the process in step S37 is performed as in the same manner.

If the comparison result is bad, that is, if accepted frame 300 is not data addressed to host system 100 (NO in step S35), CPU 101 transmits accepted frame 300 as it is to power feed line 122 for external PLC through PS unit 109, PS unit 111 and line 110 (step S39).

The data outputted to power feed line 112 is provided to each of television set 405 and router 401 through bridge device 400. Television set 405 determines whether the data is data addressed thereto. If the data is not data addressed to television set 405, television set 405 discards the data. On the other hand, if the data is data addressed to television set 405, television set 405 outputs the data.

Router 401 makes copies of frame 300. Then, router 401 outputs the copies, that is, the plurality of frames 300 to the terminals connected to WEB 402, respectively. Accordingly, each of terminals 1, such as terminal STD, connected to WEB 402 receives frame 300 and, then, compares DA 311 of received frame 300 with a MAC address thereof to determine whether frame 300 is data addressed thereto, based on a result of the comparison. If frame 300 is data addressed to terminal 1, terminal 1 accepts data in frame 300 and, then, processes the data.

In accordance with the configuration shown in FIG. 1, a terminal 1 that determines that frame 300 relayed by another terminal 1 in the AP mode is data addressed thereto, and finally receives frame 300. Such a terminal 1 receives frames 300, which are equal to one another, repeatedly from peripheral terminals 1 each serving as an AP terminal. Therefore, terminal 1 collates data ‘SNUM’ in received frame 300 with data ‘SNUM’ in received frame 300, and then discards the data, based on a result of the collation. Specifically, if terminal 1 determines that data ‘SNUM’ in frame 300 received early is equal in identification information (serial number) to data ‘SNUM’ in frame 300 received subsequently, based on the collation result, then, terminal 1 discards frame 300 received subsequently. This configuration prevents a buffer for storing received data from overloading and avoids an error operation that a plurality of pieces of data which are equal to one another are processed repeatedly.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information communication terminal for carrying out communications on a wireless network, comprising:
a communication unit carrying out communications with an external apparatus using a frame on said wireless network; and
an information processing unit performing information processing using said frame received by said communication unit, wherein:
said communication unit includes a mode determination portion determining which one of a first mode and a second mode is set as an operating mode of said information communication terminal;
when said mode determination portion determines that said operating mode is set at said first mode, said communication unit outputs said received frame to said information processing unit; and
when said mode determination portion determines that said operating mode is set at said second mode, said communication unit transmits said received frame through said wireless network.

2. The information communication terminal according to claim 1, further comprising:
a power supply unit supplying electric power to each circuit of said information communication terminal; and
a charge state determination unit determining whether said power supply unit is in a charge state, wherein
said operating mode is set at one of said first mode and said second mode in accordance with a result of the determination by said charge state determination unit.

3. The information communication terminal according to claim 2, wherein when said charge state determination unit determines that said power supply unit is in said charge state, said operating mode is set at said second mode.

4. The information communication terminal according to claim 2, wherein:
said power supply unit becomes charged with electric power supplied from a power feed line connected to said information communication terminal;
said information processing unit includes an external communication portion transmitting said received frame to an external through said power feed line; and
when said charge state determination unit determines that said power supply unit is in said charge state and the information communication terminal is instructed to carry out communications with said external, said operating mode is set at said first mode.

5. The information communication terminal according to claim 2, wherein
when said charge state determination unit determines that said power supply unit is in said charge state and the information communication terminal is instructed to allow said information processing unit to execute a predetermined application, said operating mode is set at said first mode.

6. The information communication terminal according to claim 1, wherein:
said communication unit includes a program storage portion having a predetermined storage area in which a program received from said information processing unit is stored in an overwriting manner, and operates in accordance with the program stored in said predetermined storage area;
when said operating mode is set at said first mode, said information processing unit outputs to said communication unit a first program for allowing said communication unit to serve as said first mode; and
when said operating mode is set at said second mode, said information processing unit outputs to said communication unit a second program for allowing said communication unit to serve as said second mode.

7. The information communication terminal according to claim 1, wherein
said external apparatus is another said information communication terminal.

8. A wireless communication device installed in an information communication terminal for carrying out communications on a wireless network, comprising:
a communication unit carrying out communications with an external apparatus using a frame on said wireless network; and
an information processing unit performing information processing using said frame received by said communication unit, wherein:
said communication unit includes a mode determination portion determining which one of a first mode and a second mode is set as an operating mode of said information communication terminal;
when said mode determination portion determines that said operating mode is set at said first mode, said communication unit outputs said received frame to said information processing unit; and
when said mode determination portion determines that said operating mode is set at said second mode, said communication unit transmits said received frame through said wireless network.

9. A wireless communication network comprising a plurality of information communication terminals carrying out mutual wireless communications with one another, wherein
a first information communication terminal among said plurality of information communication terminals includes:
a communication unit carrying out wireless communications with a second information communication terminal among said plurality of information communication terminals using a frame; and
an information processing unit performing information processing using said frame received by said communication unit,
said communication unit includes a mode determination portion determining which one of a first mode and a second mode is set as an operating mode of said first information communication terminal,
when said mode determination portion determines that said operating mode is set at said first mode, said communication unit outputs said received frame to said information processing unit, and
when said mode determination portion determines that said operating mode is set at said second mode, said communication unit transmits said received frame by said wireless communications.
